(19) United States
(12) Patent Application Publication
(10) Pub. No.: US 2015/0052808 A1
(43) Pub. Date: Feb. 26, 2015

(54) GARDENING BOX

(71) Applicants: Li Wang, Yixing (CN); Mingquan Xu, Yixing (CN); Jie Li, Yixing (CN); Steven Lin, City of Industry, CA (US)

(72) Inventors: Li Wang, Yixing (CN); Mingquan Xu, Yixing (CN); Jie Li, Yixing (CN); Steven Lin, City of Industry, CA (US)

(21) Appl. No.: 14/010,318

(22) Filed: Aug. 26, 2013

(51) Int. Cl. A01G 9/02

(52) U.S. Cl. CPC A01G 9/02
USPC 47/65.5

(57) ABSTRACT

A gardening box is disclosed. The gardening box may include a main body having a receiving space; a separation board having a plurality of through holes to secure water absorbing units and dividing said receiving space into an upper space and a bottom space; a plurality of observing holes located at a lower portion outside the main body; and a plurality of water absorbing unit secured at the separation board, and a lower portion of the water absorbing unit exposes at the bottom space to absorb water from the bottom space to moisturize soil and plants thereabove. Water level can be observed from the observing holes because the water level of the bottom space is identical to the observing holes according to the law of communicating vases.

### FIELD OF THE INVENTION

The present invention is directed to a gardening box, and in particular to a gardening box that is eco-friendly, convenient for households and able to control water level therein.

### BACKGROUND OF THE INVENTION

Currently, planting vegetables, flowers or plants is very common among majority of households as a hobby or even an extra source of income. As the popularity of household planting increases, the need for a convenient and efficient gardening box has also emerged. Because most households nowadays do not own a large lot for outdoor planting, they would prefer to plant in a gardening box that can be placed in any setting. Also, common and ordinary gardening boxes have hole on the bottom of the container to prevent the soil from overly-moist, which would have damaged the plant. These boxes are not very convenient because the water level therein is difficult to know and control, and the water flowing out of the hole would dirty the surrounding area. As result, numerous of ego-friendly gardening boxes have been developed to bring convenience and efficiency to common households.

U.S. Pat. Pub. No.: 2002/0152676 to Chan discloses a plant water absorbing container, wherein two sides of the water tank are installed with at least one holes which is lower than the net frame. A plurality of water absorbing cottons are disposed above the net frame. A water absorbing cotton is placed between the net frame and the culture disk so as to generate a siphonage so that water permeates into the water absorbing cotton from the center portion thereof. It is noted that many plants need constant moist soil but cannot survive in overly moist soil or overly-dried soil. For a common household planter, it is hard to grasp the balance between overly-moist and overly dried. It is also inconvenient for common household planter to constantly keep track of the water level for the plants. While Chan discloses an improved plant water absorbing container to prevent the water flowing out from the container, it is difficult for the user to know the amount the water therein outside the container and the plants therein might die because the user cannot make adjustment when the water level is inappropriate.

Therefore, there remains a need for a new and improved gardening box that enables users to observe the water level outside the box and further adjust the amount of water therein to provide the best condition for the soil and plants.

### SUMMARY OF THE INVENTION

It is an object of the present invention to provide a gardening box that enables users to observe the water level outside the box and further adjust the amount of water therein to provide the best condition for the soil and plants.

It is another object of the present invention to provide a gardening box that is eco-friendly and is able to prevent unwanted leakage from the box.

It is a further object of the present invention to provide a gardening box to keep the soil constantly moist and excessive amount of water will flow to the bottom level of the garden box.

It is still a further object of the present invention to provide a gardening box that can maintain a water circulation in the gardening box, so the water is able to reach a steady state in the gardening box to provide a best condition to the soil and plants.

In one aspect, a gardening box may include a main body, a separation board, a plurality of observing holes and a plurality of water absorbing unit. The main body has a receiving space and the separation board is used to divide the receiving space into an upper space and a bottom space. A plurality of small through openings are formed on the separation board so that excessive water can pass through the through openings to the bottom space of the gardening box.

In one embodiment, the absorbing unit is used to absorb the water from the bottom space to moisturize the plant thereabove. In another embodiment, when there is excessive amount of water in the soil of the plant, the absorbing unit can transport the excessive water to the bottom space. The absorbing unit actually serves the purpose to control the water amount in the garden box to prevent the plants in the garden box being dried or drowned.

In a further embodiment, the observing holes are disposed at lower portion of the gardening box. Each observing hole has an opening and a transparent cover. According to the law of communicating vases, when the liquid settles, it balances out to the same level in all of the containers regardless of the shape and volume of the containers. Therefore, the water level of the bottom space will be identical to the water level of the observing holes. More importantly, through the observing holes, the water level at the bottom space of the garden box can be observed, so that the user can have a better understanding of the amount of water in the gardening box.

In still a further embodiment, when the water level is over the opening of the observing hole, the water may overflow and the excessive amount of water may flow out from the observing holes. In other words, the observing holes can not only serve the purpose of observing water level in the gardening box, but also control the amount of water therein to prevent the plants from being drowned. Under such circumstances, the observing holes and the absorbing unit actually play a very important role to maintain a water circulation in the gardening box, so the water can reach a steady state in the gardening box to provide the best condition to the soil and plants. The gardening box may be equipped with a plurality of wheels at a bottom portion thereof.

In an exemplary embodiment, the water level at the bottom space of the gardening box covers a portion of the absorbing unit, so that the water in the bottom space can be absorbed into the soil around or above the absorbing unit to moisturize the soil and plants. When the water comes from the above of the gardening box, most excessive water may pass through small through openings of the separation board to the bottom space, and the remaining can be absorbed by the absorbing unit and transported to the bottom space.

### BRIEF DESCRIPTION OF THE DRAWINGS

FIG. 1 illustrates a prior art of a gardening box.

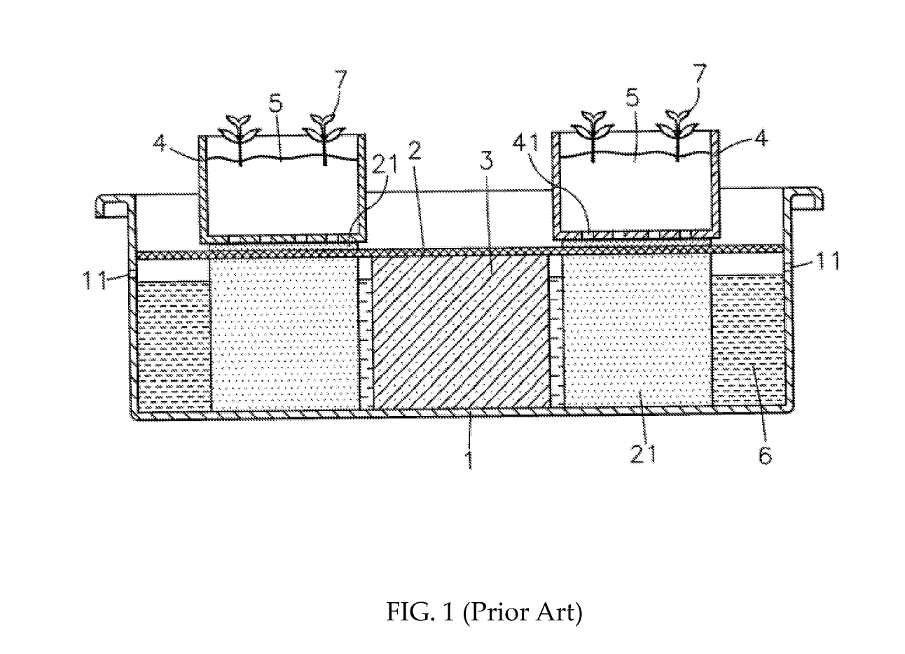

FIG. 2 illustrates a schematic view a gardening box in the present invention.

FIG. 3 illustrates an exploded view of the gardening box in the present invention.

FIG. 4 illustrates one embodiment of the gardening box in the present invention.

FIG. 5 illustrates a schematic view of the gardening box in the present invention when the gardening box is in use.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

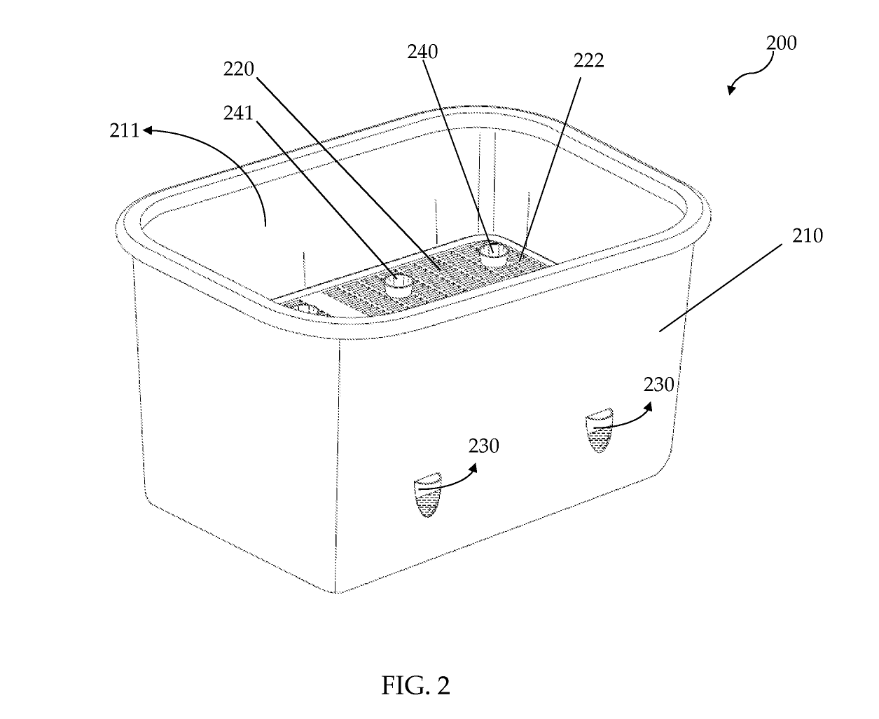

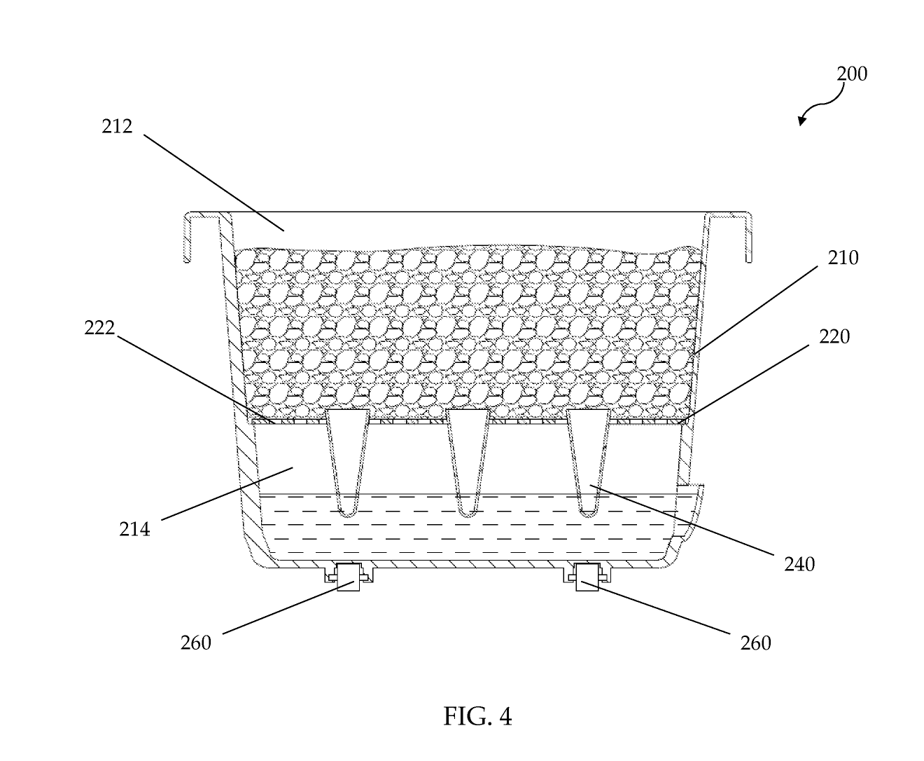

As shown in FIGS. 2 to 4, a gardening box 200 may include a main body 210, a separation board 220, a plurality of observing holes 230 and a plurality of water absorbing unit 240. The main body 210 has a receiving space 211 and the separation board 220 is used to divide the receiving space into an upper space 212 and a bottom space 214. A plurality of small through openings 222 are formed on the separation board 220 so that excessive water can pass through the through openings 222 to the bottom space 214 of the gardening box 200.

The absorbing unit 240 is hollow and made by ceramic with an upper opening 241. The absorbing units 240 are disposed at the separation board 220 and more specifically, the absorbing unit 240 is inserted into a through hole 224 on the separation board 220 and the absorbing unit 240 can be secured on the separation board 220. A lower portion of the absorbing unit 240 exposes at the bottom space 214 and is used to absorb the water therefrom to moisturize the soil and plants thereabove. On the other hand, when there is excessive amount of water in the soil or the plant, the absorbing unit 240 can transport the excessive water to the bottom space 214. The absorbing unit 240 actually serves the purpose to control the water amount in the garden box 200 to prevent the plants in the garden box 200 being dried or drowned. To conveniently carry or move the gardening box 200, it may be equipped with a plurality of wheels 260 at a bottom portion thereof.

The observing holes 230 are disposed at lower portion of the gardening box 200. Each observing hole 230 has an opening 231 and a transparent cover 232. According to the law of communicating vases, when the liquid settles, it balances out to the same level in all of the containers regardless of the shape and volume of the containers. Therefore, the water level of the bottom space 214 will be identical to the water level of the observing holes 230. More importantly, through the observing holes 230, the water level at the bottom space 214 of the garden box 200 can be observed, so that the user can have a better understanding of the amount of water in the gardening box 200.

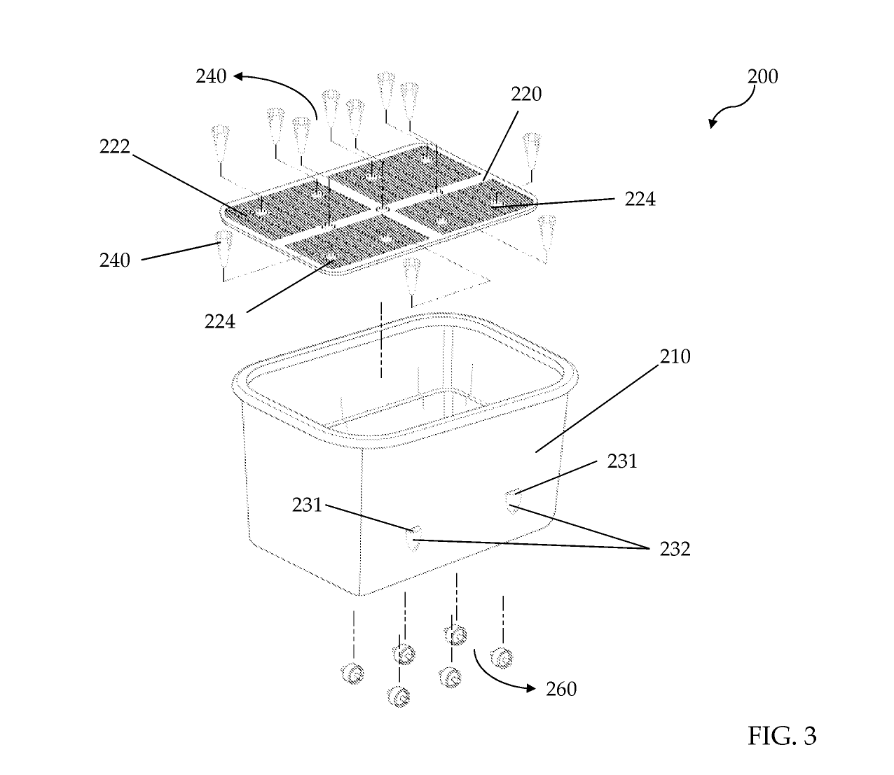

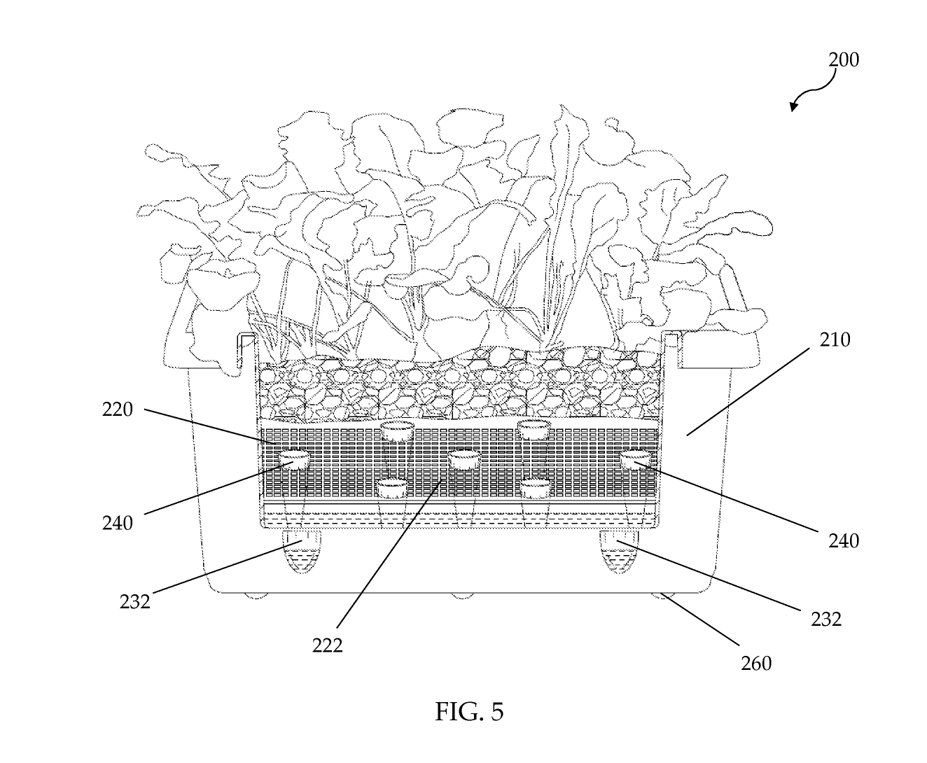

Referring to FIGS. 3 and 5, when the gardening box 200 is in use, the soil and plants are disposed on the separation board 220 and the user can either water the plants and soil thereabove or pour the water from the observing holes 230. According to the law of communicating vases, when the user pours the water into the gardening box 200 through the observing holes 230, the water level that can be seen in the observing holes 230 should be identical anywhere of the gardening box 200 having the same height as the observing holes 230. When the water level is over the opening 231 of the observing hole 230, the water may overflow and the excessive amount of water may flow out from the observing holes 230. In other words, the observing holes 230 can not only serve the purpose of observing water level in the gardening box 200, but also control the amount of water therein to prevent the plants from being drowned. Under such circumstances, the observing holes 230 and the absorbing unit 240 actually play a very important role to maintain a water circulation in the gardening box 200, so the water can reach a steady state in the gardening box 200 to provide the best condition to the soil and plants. In one embodiment, the height of the observing holes 230 can be changed according to the user's preference. In an exemplary embodiment, the water level at the bottom space 214 of the gardening box 200 covers a portion of the absorbing unit 240, so that the water in the bottom space 214 can be absorbed into the soil around or above the absorbing unit 240 to moisturize the soil and plants.

When the water comes from the above of the gardening box 200, most excessive water may pass through small through openings 222 of the separation board 220 to the bottom space 214, and the remaining can be absorbed by the absorbing unit 240 and transported to the bottom space 214. More importantly, the observing holes 230 can be used as draining holes, and the excessive water can flow out therefrom.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A gardening box comprising:
a main body having a receiving space;
a separation board having a plurality of through holes to secure water absorbing units and dividing said receiving space into an upper space and a bottom space, wherein soil and plants are disposed on the separation board;
a plurality of observing holes located at a lower portion outside the main body; and
a plurality of water absorbing unit secured at the separation board, and a lower portion of the water absorbing unit exposes at the bottom space to absorb water from the bottom space to moisturize soil and plants thereabove;
wherein water level is observed from the observing holes because the water level of the bottom space is identical to the observing holes according to the law of communicating vases.

2. The gardening box of claim 1, wherein a plurality of small through openings are located on the separation board, so that excessive water is able to pass through the through openings to the bottom space of the gardening box.

3. The gardening box of claim 1, wherein the water absorbing unit is hollow and made by ceramic.

4. The gardening box of claim 1, wherein when there is excessive amount of water in the soil or in the plant, the absorbing unit is able to transport the excessive water to the bottom space.

5. The gardening box of claim 1, wherein the water observing unit has an opening and a transparent cover, and the water level of the bottom space is observed through the transparent cover.

6. The gardening box of claim 5, wherein when the water level in the bottom space is over the opening of the water observing unit, the water flows out from the gardening box through the opening until the water level reaches at least the same level of the opening of the water observing unit.

7. The gardening box of claim 1, wherein height of the observing holes is changeable on the gardening box according to the user's preference.

8. The gardening box of claim 6, wherein height of the observing holes is changeable on the gardening box according to the user's preference.

9. The gardening box of claim 1, further comprising a plurality of wheels at a bottom portion of the gardening box.

10. The gardening box of claim 1, wherein the water observing hole is used to receive water from the opening thereof.

11. The gardening box of claim 1, wherein the water absorbing units and the water absorbing holes are used to maintain a water circulation in the gardening box, so the water is able to reach a steady state in the gardening box to provide a best condition to the soil and plants.

12. The gardening box of claim 6, wherein the water absorbing units and the water absorbing holes are used to maintain a water circulation in the gardening box, so the water is able to reach a steady state in the gardening box to provide a best condition to the soil and plants.
